(19) United States
(12) Patent Application Publication
(10) Pub. No.: US 2010/0117827 A1
(43) Pub. Date: May 13, 2010

(54) METHOD FOR CURRENT REDUCTION FOR AN ANALOG CIRCUIT IN A DATA READ-OUT SYSTEM

(75) Inventors: Bing-Yu Hsieh, Taipei City (TW); Wei-Hsuan Tu, Hsinchu City (TW); Chih Chuan Chen, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/269,248

(22) Filed: Nov. 12, 2008

(51) Int. Cl. G08B 21/00

(52) U.S. Cl. 340/540

(57) ABSTRACT

The invention provides a method for current reduction for an analog circuit in a data read-out system. First, a performance indicator, indicating a performance of the data read-out system is generated. The performance indicator is then compared with a performance threshold level to generate a switch signal. A level of a current source biasing the analog circuit is then adjusted according to the switch signal.

### BACKGROUND OF THE INVENTION

1. Field of the Invention

The invention relates to data read-out systems, and more particularly to current reduction for analog circuit in a data read-out system.

2. Description of the Related Art

A data read-out system, such as an optical disk drive, comprises an analog front-end circuit and a digital signal processing system. The analog front-end circuit retrieves a raw data signal from a data storage device and processes the raw data signal to obtain an analog data signal with better signal property. After the analog data signal is converted to a digital data signal, the digital signal processing system can digitally process the digital data signal.

Referring to FIG. 1, a block diagram of a conventional data read-out system 100 is shown. The data read-out system 100 comprises an analog front-end circuit 104 and a digital signal processing system 106. A photo-detector integration circuit (PDIC) 102 first retrieves a raw data signal S₁ from a data storage media, such as an optical disk. The analog front-end circuit 104 comprises a summing circuit 112, an automatic gain controller 114, an equalizer 116, and an analog-to-digital converter 118. The summing circuit 112 sums raw data signals S₁ generated by multiple photo-detectors to obtain a sum signal S₂. The automatic gain controller 114 then amplifies the sum signal S₂ to obtain an amplified signal S₃. The equalizer 116 then filters the amplified signal S₃ to obtain a filtered signal S₄. The analog-to-digital converter 118 then converts the filtered signal S₄ from analog to digital and obtains a digital signal S₅. The digital signal processing system 106 can then processes the digital signal S₅.

Compared to a digital signal processing system, a circuit design of an analog front-end circuit is more complicated and more confined to limited circuit resources. For example, an analog front-end circuit requires a large chip area for implementation. In addition, an analog front-end circuit requires large power consumption. If the chip area or the power consumption of the analog front-end circuit is reduced, the circuit performance of the analog front-end circuit degrades. The circuit performance of an analog front-end circuit therefore often determines the circuit performance of a data read-out system. Thus, in exchange for reducing power consumption of a data read-out system, the circuit performance of an analog front-end circuit must be lowered.

When circuit performance of an analog front-end circuit is lowered, read performance of a data read-out system does not always degrade. Read performance of a data read-out system is determined by two factors, signal quality and the circuit performance of the analog front-end circuit. When signal quality is good enough, degradation of performance of the analog front-end circuit only slightly lowers read performance of a data read-out system. Thus, slight degradation of performance of the analog front-end circuit is tolerable in exchange for reduction of power consumption when signal quality is good. The invention therefore provides a method for current reduction for an analog circuit in a data read-out system.

### BRIEF SUMMARY OF THE INVENTION

The invention provides a method for current reduction for an analog circuit in a data read-out system. First, a performance indicator indicating a performance of the data read-out system is generated. The performance indicator is then compared with a performance threshold level to generate a switch signal. A level of a current source biasing the analog circuit is then adjusted according to the switch signal.

The invention also provides a data read-out system capable of automatically reducing current consumption. In one embodiment, the data read-out system comprises a performance indicator generator, a switch signal generator, and an analog circuit. The performance indicator generator generates a performance indicator indicating a performance of the data read-out system. The switch signal generator then compares the performance indicator with a performance threshold level to generate a switch signal. The analog circuit then adjusts a level of a current source biasing the analog circuit according to the switch signal.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional data read-out system;

FIG. 2 is a block diagram of a data read-out system automatically reducing current consumption according to the invention;

FIG. 3 is a flowchart of a method for current reduction for a data read-out system according to the invention;

FIG. 4 is a block diagram of a performance indicator generator and a switch signal generator according to the invention;

FIG. 5A shows an gain stage of the summing circuit or the automatic gain controller of FIG. 2 according to the invention;

FIG. 5B shows a transfer curve between an input voltage and an output voltage of the gain stage of FIG. 5A;

FIG. 6A shows a compensation circuit of an equalizer of FIG. 2 according to the invention;

FIG. 6B shows an equalizing cell of an equalizer of FIG. 2 according to the invention;

FIG. 6C is a bode plot of a gain and a phase of the equalizing cell of FIG. 6B;

FIG. 6D shows a transfer curve between an input voltage and an output current of the compensation circuit of FIG. 6A;

FIG. 7A is a block diagram of a flash analog-to-digital converter of FIG. 2; and

FIG. 7B shows a pre-amplifier of a flash analog-to-digital converter of FIG. 7A.

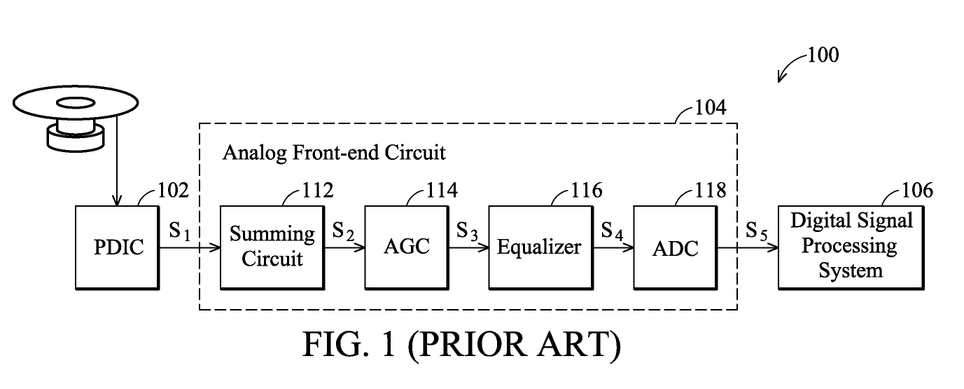

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

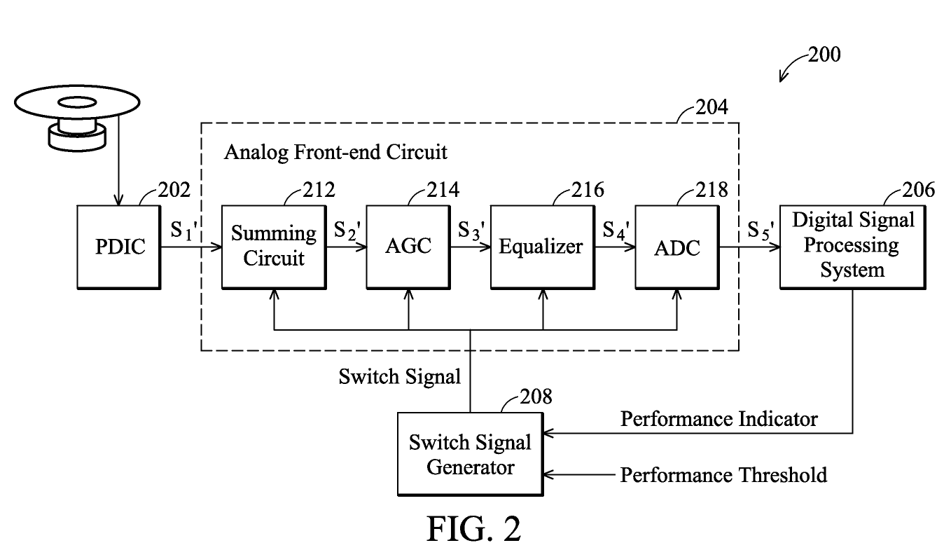

Referring to FIG. 2, a block diagram of a data read-out system 200 automatically reducing current consumption according to the invention is shown. The data read-out system 200 reads data from a data storage device. In one embodiment, the data read-out system 200 is an optical disk drive retrieving data from an optical disk. The data read-out system 200 comprises an analog front-end circuit 204, a digital signal processing system 206, and a switch signal generator 208. A photo-detector integration circuit (PDIC) 202 first retrieves a raw data signal S₁′ from an optical disk. The analog front-end circuit 204 then processes the raw data signal S₁′, and then converts the processed data signal from analog to digital to obtain a digital signal S₅′. The digital signal processing system 206 then derives data from the digital signal S₅′ and delivers the data to a host (not shown). Thus, the data read-out system 200 retrieves data from the data storage device for the host.

During data reading, the data read-out system 200 monitors a read performance thereof. When the read performance is good, the data read-out system 200 reduces a level of a current source which biases the analog front-end circuit 204 for power consumption reduction without affecting normal operation of the analog front-end circuit 204. For example, signal gain, filtration bandwidth, and output signal resolution of the analog front-end circuit 204 are not altered after the level of the biasing current source is reduced. Slight signal distortion occurs due to current reduction, but the signal distortion is tolerable when signal quality is good. The data read-out system 200 continues to monitor the read performance. If the read performance is lower than a threshold level, the biasing current is increased so that the read performance returns to a higher threshold level. Thus, the read performance is maintained at a higher threshold level.

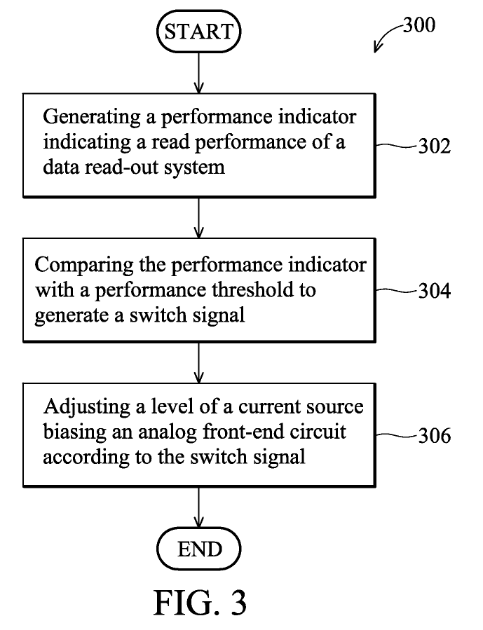

Referring to FIG. 3, a flowchart of a method 300 for current reduction for a data read-out system according to the invention is shown. The data read-out system 200 implements the method 300 to reduce power consumption of the analog front-end circuit 204. First, the digital signal processing system 206 generates a performance indicator, indicating a read performance of the data read-out system 200 (step 302). In one embodiment, the digital signal processing system 206 generates the performance indicator according to a frame error signal representing a number of erroneous data frames generated by the data read-out system 200. The switch signal generator 208 then compares the performance indicator with a performance threshold level to generate a switch signal (step 304).

In one embodiment, the performance threshold level comprises an upper performance threshold level and a lower performance threshold level. When the performance indicator is greater than the upper performance threshold level, the switch signal generator 208 sets the switch signal to a high level to indicate that the read performance is bad. When the performance indicator is less than the lower performance threshold level, the switch signal generator 208 clears the switch signal to a low level to indicate that the read performance is good.

For example, the performance indicator can be generated according to the amount of erroneous data frames. When the performance indicator is greater than the upper performance threshold level, it means that too many errors occur, and the read performance is bad. When the performance indicator is less than the lower performance threshold level, it means that just few errors occur, and the read performance is good.

In other embodiments, if the performance indicator is non-linear, the performance threshold level may comprise a first performance threshold level and a second performance threshold level. When the performance indicator is beyond a range between the first performance threshold level and the second performance threshold level, the read performance is bad. When the performance indicator is within the range between the first performance threshold level and the second performance threshold level, the read performance is good. On the other hand, the performance indicator also can indicate the read performance is bad when itself within the range between the first performance threshold level and the second performance threshold level.

The analog front-end circuit 204 then adjusts a level of a current source which biases the analog-front end circuit 204 according to the switch signal (step 306). When the switch signal indicates that the read performance of the data read-out system 200 is good, the analog front-end circuit 204 decreases the level of the biasing current source to reduce power consumption. When the switch signal indicates that the read performance is bad, the analog front-end circuit 204 increases the level of the biasing current source to increase the read performance of the data read-out system 200. Thus, the read performance of the data read-out system 200 is always maintained at a suitable level when compared with the performance threshold level.

In one embodiment, the analog front-end circuit 200 comprises a summing circuit 212, an automatic gain controller 214, an equalizer 216, and an analog-to-digital converter 218. The summing circuit 212 sums signals S_{1′} generated by photo-detectors 202 to obtain a sum signal S_{2′}. The automatic gain amplifier 214 then amplifies the sum signal S_{2′} to obtain an amplified signal S_{3′}. The equalizer 216 then filters the amplified signal S_{3′} to obtain a filtered signal S_{4′}. The analog-to-digital converter 218 then converts the filtered signal S_{4′} from analog to digital to obtain a digital signal S_{5′}. Finally, the digital signal S_{5′} is delivered to the digital signal processing system 206 for subsequent signal processing.

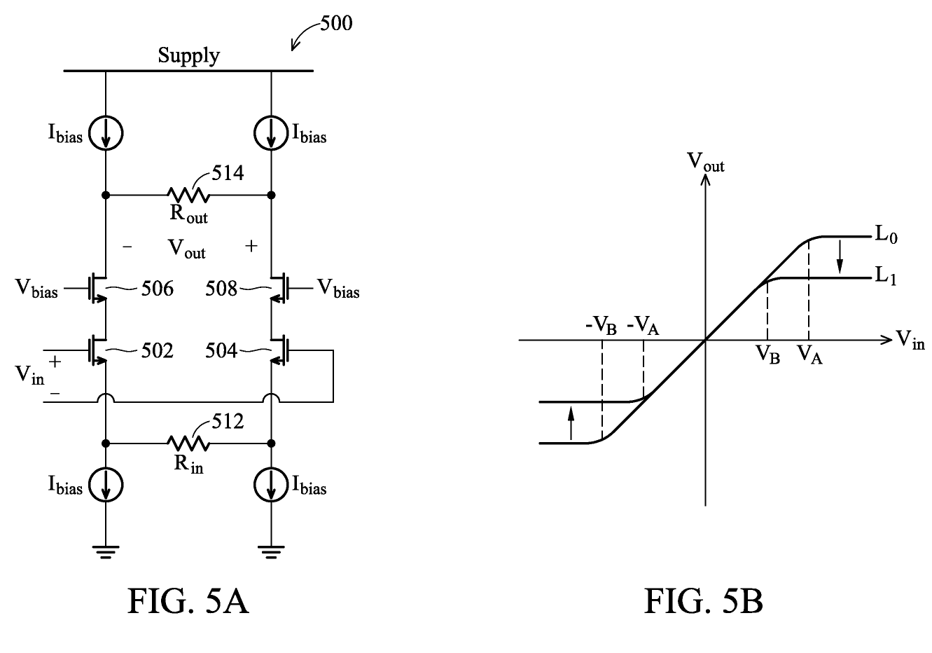

The analog front-end circuit 200 adjusts the level of the current source which biases a gain stage or a trans-conductance stage (included within a gain stage in some embodiments) of the summing circuit 212, the equalizer 216, or the analog-to-digital converter 218. In one embodiment, the gain stage or the trans-conductance stage can be implemented as a gain amplifier or a pre-amplifier. Because the gain stage or the trans-conductance stage has an adjustable current bias, operations of the summing circuit 212, the equalizer 216, and the analog-to-digital converter 218 are not affected by the biasing current reduction. The biasing current adjustment of the summing circuit 212, the equalizer 216, and the analog-to-digital converter 218 is further described in detail using FIGS. 5, 6, and 7.

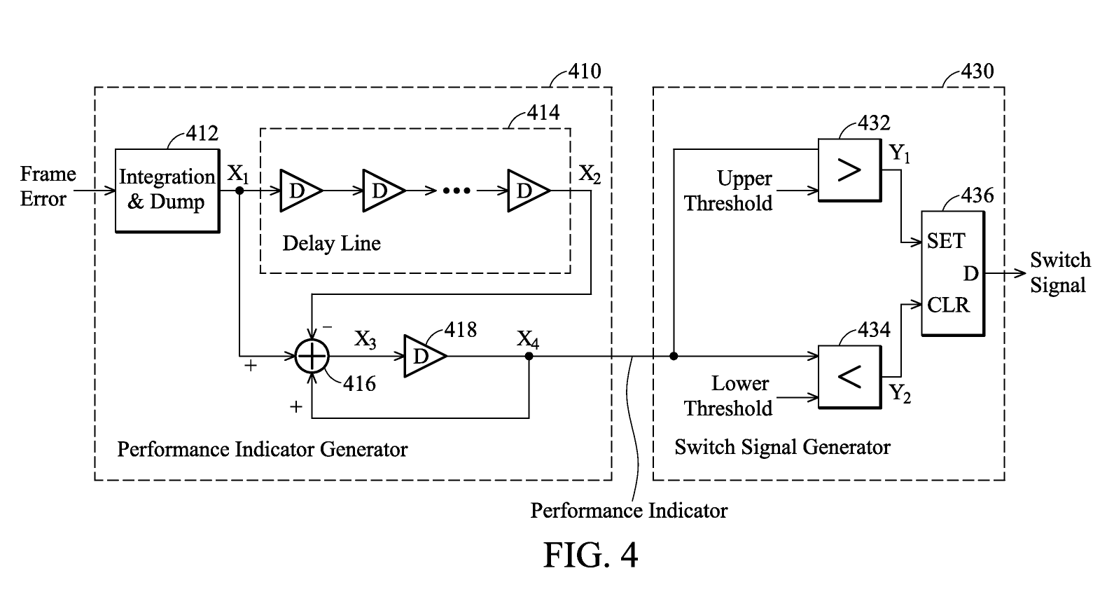

Referring to FIG. 4, a block diagram of a performance indicator generator 410 and a switch signal generator 430 according to the invention is shown. The performance indicator generator 410 can be comprised by the digital signal processing system 206 and generates a performance indicator according to a frame error signal of the digital signal processing system 206. The frame error signal represents a number of erroneous data frames generated by the digital signal processing system 206.

The performance indicator generator 410 comprises an integration and dump circuit 412, a delay line 414, an adder 416, and a delay cell 418. The integration and dump circuit 412 generates a cumulative sum of the frame error signals of the data read-out system during a predetermined period to obtain a fixed period error signal Xi. The fixed period error signal X₁ indicates a total amount of error frames in a fixed period, such as N frames, thus a moving window is predetermined to shift N frames each iteration. The delay line 414 then delays the fixed-period error signal X₁ to obtain a delayed error signal X₂, wherein the delay line 414 has M stages, and X₂ is derived from the last stage of the delay line 414. The adder 416 then subtracts the delayed error signal X₂ from a sum of the fixed-period error signal X₁ and a performance indicator X₄ to obtain a moving-window error signal X₃. Finally, the delay cell 418 delays the moving-window error signal X₃ to obtain the performance indicator X₄. Thus, the performance indicator X₄ indicates an error amount in the moving window with size of N*M frames.

For example, in a digital versatile disk (DVD), a error correction code (ECC) block contains 16 sectors, and each sector comprises 13 frames. When a moving window size is set to an ECC block size, a moving window comprises 208 (=16×13) frames. Every time when the moving window scans through all 13 frames of a sector, the integration and dump circuit outputs a sample of the fixed period error signal X₁ to indicate a total number of error frames in the sector, and then moves forward to scan frames of a next sector. Thus, the performance indicator X₄ properly indicates a performance measure of data recorded on the digital versatile disk.

The switch signal generator 430 comprises two comparators 432 and 434, and a latch circuit 436. When the performance indicator X₄ is greater than an upper performance threshold level, the comparator 432 generates a comparison result Y₁ to set the latch circuit 436. Thus, the latch circuit 436 generates a switch signal with a high level to indicate that the read performance is bad. When the performance indicator X₄ is less than a lower performance threshold level, the comparator 434 generates a comparison result Y₂ to clear the latch circuit 436. Thus, the latch circuit 436 generates a switch signal with a low level to indicate that the read performance is good. This implementation with two performance threshold levels can prevent the switch signal varies too often when the performance indicator X4 is unstable.

Referring to FIG. 5A, a schematic diagram of gain stage 500 of the summing circuit 212 or the automatic gain controller 214 according to the invention is shown. A current source I_{bias} biases the gain stage 500. An input resistor 512 with resistance Rᵢₙ is coupled between the sources of the transistors 502 and 504. An output resistor 514 with resistance Rₒᵤₜ is coupled between the drains of transistors 506 and 508. When an input voltage Vᵢₙ is applied across the gates of transistors 502 and 504, the gain stage 500 generates an output voltage Vₒᵤₜ across the output resistor Rₒᵤₜ.

Assume that the transistors 502 and 504 have a trans-conductance gₘ. The gain G of the gain stage 500 is determined according to the following algorithm:

$$G = \frac{{V}_{o}}{{V}_{in}} = \frac{2 {R}_{out}}{\frac{2}{{g}_{m}} + {R}_{in}} ≅ \frac{2 {R}_{out}}{{R}_{in}} . \qquad ( 1 )$$

The resistance Rᵢₙ is often designed to be much greater than (2/gₘ), so that the gain G turns into the value (2Rₒᵤₜ/Rᵢₙ) and is merely determined by the resistances Rᵢₙ and Rₒᵤₜ. Thus, when the level of the biasing current I_{bias} is decreased, although the trans-conductance gₘ decreases with the biasing current I_{bias}, the gain G of the gain stage 500 is kept constant.

Because the gain G of the gain stage 500 does not change with the biasing current I_{bias}, operation of the gain stage 500 is not affected by adjustment of the biasing current I_{bias}. Referring to FIG. 5B, a transfer curve between an input voltage Vᵢₙ and an output voltage Vₒᵤₜ of the gain stage 500 of FIG. 5A is shown. When the level of the biasing current I_{bias} is reduced, the transfer curve L₀ becomes the transfer curve L₁. Although the transfer curves L₀ and L₁ have the same slope G, the transfer curves L₀ and L₁ have different linear ranges. Thus, the output voltage Vₒᵤₜ suffers from slight signal distortion due to adjustment of the biasing current I_{bias}. The slight signal distortion, however, does not affect subsequent signal processing if signal quality is good enough.

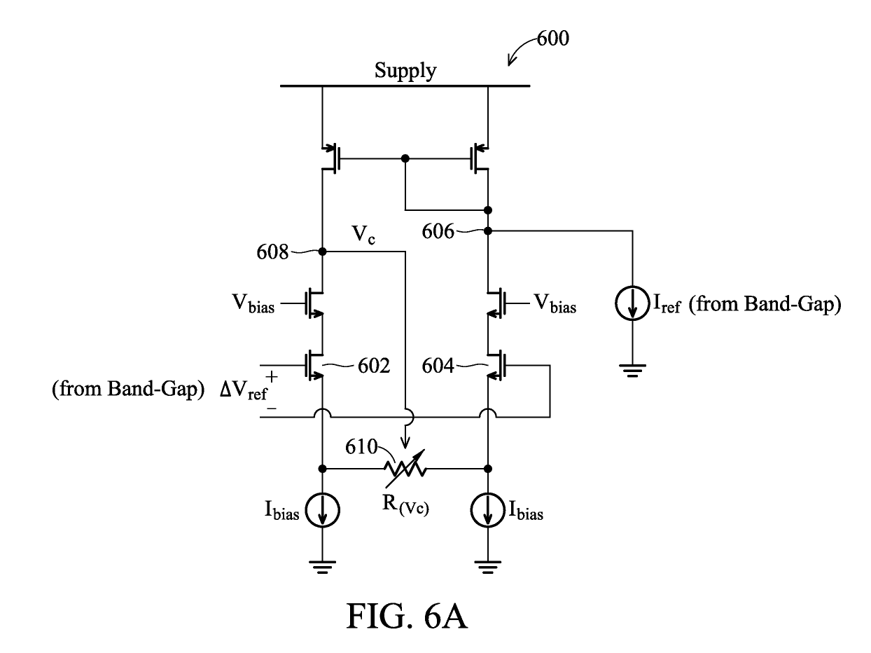

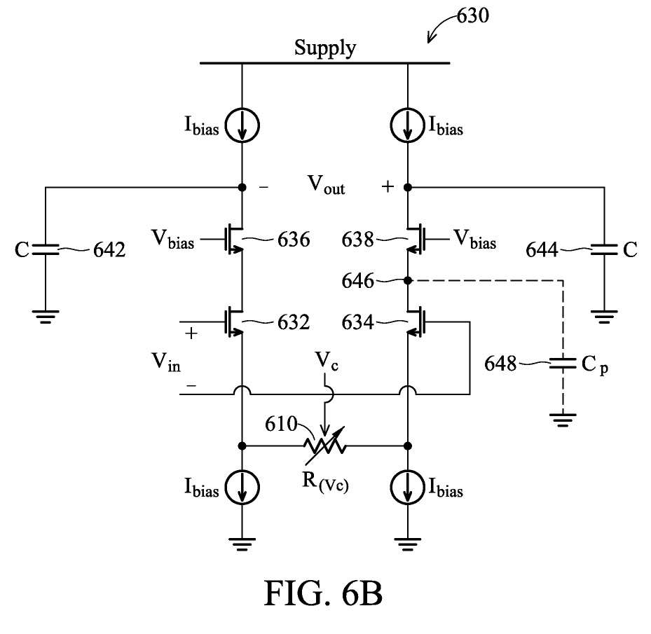

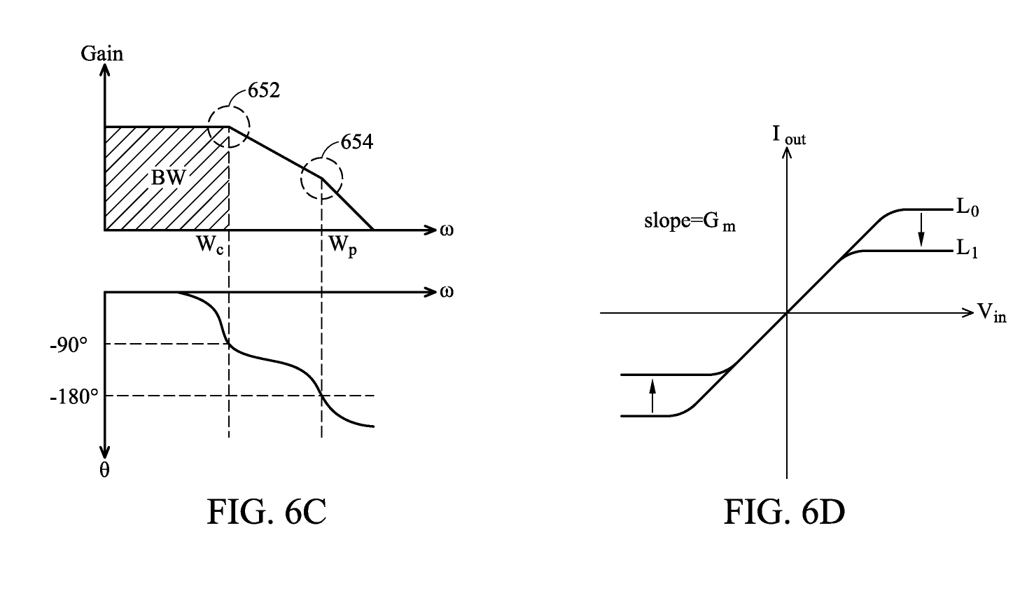

Referring to FIG. 6A, a compensation circuit 600 of an equalizer 216 according to the invention is shown. The compensation circuit 600 has an input voltage ΔV_{ref} applied across the gates of transistors 602 and 604, and has a reference current I_{ref} at a node 606. Both the input voltage ΔV_{ref} and the reference current I_{ref} are controlled by a band-gap. The resistance R_{(Vc)} of a voltage-controlled resistor 610 coupled between sources of the transistors 602 and 604 is determined by a control voltage V_{c} generated at a node 608.

Assume that the transistors 602 and 604 have trans-conductance gₘ, and the trans-conductance Gₘ of the compensation circuit 600 is then determined according to the following algorithm:

$${G}_{m} = \frac{{I}_{ref}}{Δ {V}_{ref}} = \frac{2}{\frac{2}{{g}_{m}} + {R}_{( Vc )}} . \qquad ( 2 )$$

When the biasing current I_{bias} is decreased for power consumption reduction, because the input voltage ΔV_{ref} and the output current I_{ref} are controlled by a band-gap and are not affected by a biasing current I_{bias}, the trans-conductance Gₘ of the compensation circuit 600 is invariant. Thus, when the trans-conductance gₘ decreases with reduction of the biasing current I_{bias}, the resistance R_{(Vc)} of a voltage-controlled resistor 610 automatically decreases to keep the Gₘ constant.

Referring to FIG. 6B, an equalizing cell 630 of an equalizer 216 according to the invention is shown. The resistance R_{(Vc)} of a voltage-controlled resistor 610 of equalizing cell 630 is controlled by the control voltage V_{c} generated by the compensation circuit 600 of FIG. 6A. The equalizing cell 630 has an input voltage Vᵢₙ applied across the gates of transistors 632 and 634 and generates an output voltage Vₒ between the drains of transistors 636 and 638. The transistors 632 and 634 also have trans-conductance gₘ. Two capacitors 642 and 644 with capacitance C are respectively coupled between a ground and the drains of the transistors 636 and 638. A parasitic capacitance Cₚ is represented to be coupled between a node 646 and the ground.

Referring to FIG. 6C, a gain (Vₒ/Vᵢₙ) and a phase θ of the equalizing cell 630 are shown. The bode plot of the gain of the equalizing cell 630 at the upper half of the FIG. 6C has a major pole point 652 at a frequency W_{c} corresponding to a phase θ of (−90°), and a secondary pole point 654 at a frequency Wₚ corresponding to a phase θ of (−180°), wherein the frequency W_{c} is equal to (Gₘ/C) and the frequency Wₚ is equal to (gₘ/Cₚ). Because the gain Gₘ of the compensation circuit 600 does not change with the biasing current I_{bias}, the bandwidth W_{c} of the equalizing cell 630 is kept constant (area ‘BW’). The frequency Wₚ of the secondary pole point 654, however, is equal to (gₘ/Cₚ) and affected by the biasing current I_{bias}. When the biasing current I_{bias} is decreased, the frequency Wₚ of the secondary pole point 654 decreases and causes a slight group delay variation of the output signal Vₒ of the equalizing cell 630. The slight group delay variation, however, does not affect subsequent signal processing if signal quality is good enough.

In addition, a transfer curve of the compensation circuit 600 also changes with the biasing current I_{bias}. Referring to FIG. 6D, a transfer curve between an input voltage ΔV_{ref} and the output current I_{ref} of the compensation circuit 600 of FIG. 6A is shown. When the level of the biasing current I_{bias} is reduced, the transfer curve L₀ becomes the transfer curve L₁. Although the transfer curves L₀ and L₁ have the same slope Gₘ, the transfer curves L₀ and L₁ have different linear ranges. The output voltage Vₒᵤₜ therefore suffers from slight signal distortion due to adjustment of the biasing current I_{bias}. The slight signal distortion, however, does not affect subsequent signal processing if signal quality is good enough.

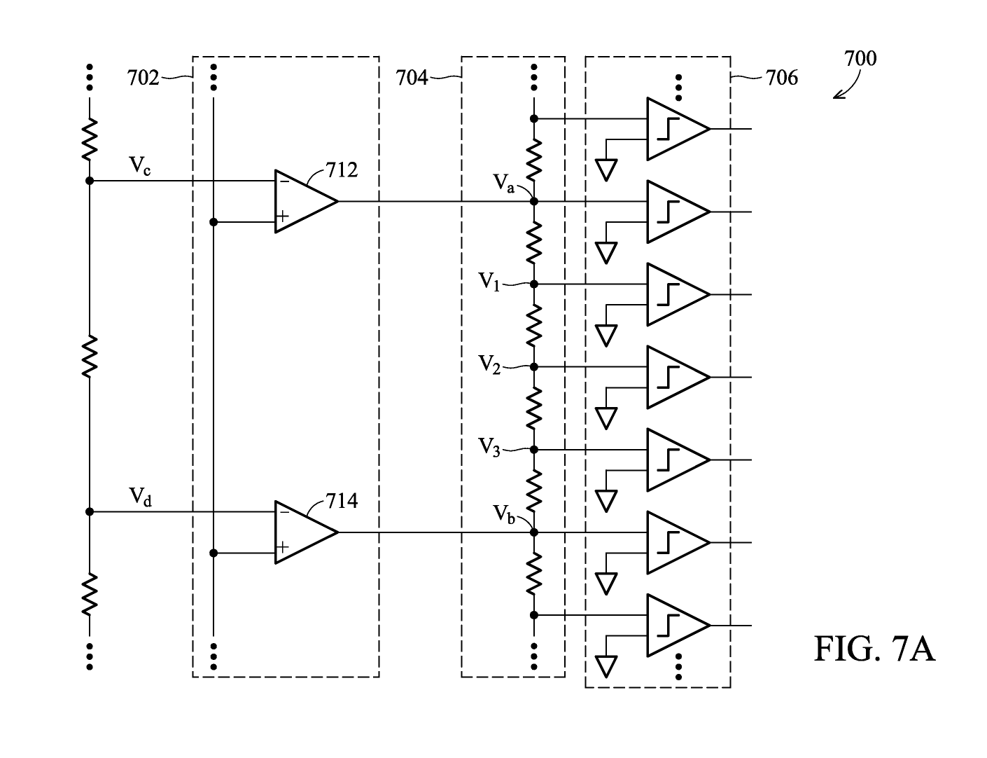

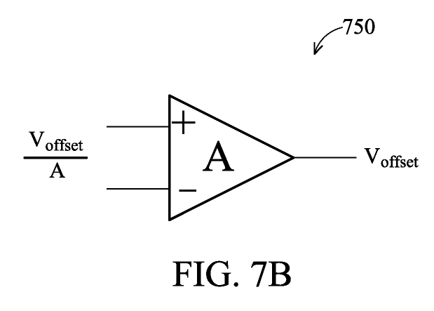

Referring to FIG. 7A, a block diagram of a flash analog-to-digital converter 700 is shown. The analog-to-digital converter 700 comprises a plurality of pre-amplifiers 702, a plurality of resistors 704, and a plurality of comparators 706. The pre-amplifiers 712 and 714 respectively amplify input voltages V_{c} and V_{d} to obtain amplified voltages Vₐ and V_{d}. The resistors 704 then generate a series of voltages V₁, V₂, and V₃ according to the amplified voltages Vₐ and V_{b}. The comparators 706 then respectively compare the voltages Vₐ, V₁, V₂, V₃, and V_{b} with a series of reference voltages to generate a series of bits of a digital output data.

When a biasing current I_{bias} of pre-amplifiers 702 of the analog-to-digital converter 700 is decreased, the gains of the pre-amplifiers 702 are reduced. Referring to FIG. 7B, a pre-amplifier 750 with a gain A and an output voltage V_{offset} is shown. If the input voltage (V_{offset}/A) is large enough, the output voltage of the pre-amplifier 750 is less than the desirable value V_{offset,} and the effective number of bits (ENOB) of the analog-to-digital converter 700 comprising the pre-amplifier 750 is reduced. The slight reduction of ENOB, however, does not affect subsequent signal processing if signal quality is good enough.

The invention provides a method for current reduction for an analog circuit in a data read-out system. A performance indicator, indicating a read performance of the data read-out system is generated. If the performance indicator indicates that the read performance is good, the level of a current biasing the analog circuit is reduced for power consumption reduction. Although reduction of the biasing current causes slight signal distortion, the analog circuit can still normally operate, and the read performance of the data read-out system is kept higher than a tolerable threshold level if the signal quality is good.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for current reduction for an analog circuit in a data read-out system, comprising:
generating a performance indicator indicating a read performance of the data read-out system;
comparing the performance indicator with a performance threshold level to generate a switch signal; and
adjusting a level of a current source biasing the analog circuit according to the switch signal.

2. The method as claimed in claim 1, wherein the performance threshold level comprises an upper performance threshold level and a lower performance threshold level, and the comparison the performance indicator comprises:
setting the switch signal to indicate that the read performance is bad when the performance indicator is greater than the upper performance threshold level; and
clearing the switch signal to indicate that the read performance is good when the performance indicator is less than the lower performance threshold level.

3. The method as claimed in claim 1, wherein the adjustment of the level of the current source comprises:
decreasing the level of the current source when the switch signal indicates that the read performance is good; and
increasing the level of the current source when the switch signal indicates that the read performance is bad.

4. The method as claimed in claim 1, wherein the level of the current source biasing a gain stage or a trans-conductance stage of component circuits of the analog circuit is adjusted, and the gain stage or the trans-conductance stage has an adjustable current bias.

5. The method as claimed in claim 4, wherein the gain stage or the trans-conductance stage is an gain stage or a pre-amplifier of a summing circuit, an automatic gain controller, an equalizer, or an analog-to-digital converter.

6. The method as claimed in claim 4, wherein the data read-out system is an optical disk drive, and the component circuits are selected from the group of a summing circuit sum signals generated by photo-detectors to obtain a sum signal, an automatic gain controller amplifying the sum signal to obtain an amplified signal, an equalizer filtering the amplified signal to obtain a filtered signal, and an analog-to-digital converter converting the filtered signal from analog to digital.

7. The method as claimed in claim 1, wherein the performance indicator is generated according to a frame error signal representing an erroneous data frames generated by the data read-out system.

8. The method as claimed in claim 7, wherein the generation of the performance indicator comprises:
generating a cumulative sum of the frame error signal of the data read-out system during a predetermined period to obtain a fixed period error signal;
delaying the fixed period error signal to obtain a delayed error signal;
subtracting the delayed error signal from a sum of the fixed period error signal and the performance indicator to obtain a moving-window error signal; and
delaying the moving-window error signal to obtain the performance indicator.

9. A data read-out system, capable of automatically reducing current consumption, comprising:
a performance indicator generator, generating a performance indicator indicating a read performance of the data read-out system;
a switch signal generator, coupled to the performance indicator generator, comparing the performance indicator with a performance threshold level to generate a switch signal; and
an analog circuit, coupled to the switch signal generator, adjusting a level of a current source biasing the analog circuit according to the switch signal.

10. The data read-out system as claimed in claim 9, wherein the performance threshold level comprises an upper performance threshold level and a lower performance threshold level, the switch signal generator sets the switch signal to indicate that the read performance is bad when the performance indicator is greater than the upper performance threshold level, and the switch signal generator clears the switch signal to indicate that the read performance is good when the performance indicator is less than the lower performance threshold level.

11. The data read-out system as claimed in claim 9, wherein the analog circuit decreases the level of the current source when the switch signal indicates that the read performance is good, and the analog circuit increases the level of the current source when the switch signal indicates that the read performance is bad.

12. The data read-out system as claimed in claim 9, wherein the analog circuit adjusts the level of the current source biasing a gain stage or a trans-conductance stage of component circuits of the analog circuit, wherein the gain stage or the trans-conductance stage has an adjustable current bias.

13. The data read-out system as claimed in claim 12, wherein the gain stage or the trans-conductance stage is an gain stage or a pre-amplifier of a summing circuit, an automatic gain controller, an equalizer, or an analog-to-digital converter.

14. The data read-out system as claimed in claim 12, wherein the data read-out system is an optical disk drive, and the component circuits are selected from the group of a summing circuit sum signals generated by photo-detectors to obtain a sum signal, an automatic gain controller amplifying the sum signal to obtain an amplified signal, an equalizer filtering the amplified signal to obtain a filtered signal, and an analog-to-digital converter converting the filtered signal from analog to digital.

15. The data read-out system as claimed in claim 9, wherein the performance indicator is generated according to a frame error signal representing a number of erroneous data frames generated by the data read-out system.

16. The data read-out system as claimed in claim 15, wherein the performance indicator generator comprises:
an integration and dump module, generating a cumulative sum of the frame error signal of the data read-out system during a predetermined period to obtain a fixed period error signal;
a delay line, delaying the fixed period error signal to obtain a delayed error signal;
an adder, subtracting the delayed error signal from a sum of the fixed period error signal and the performance indicator to obtain a moving-window error signal; and
a delay cell, delaying the moving-window error signal to obtain the performance indicator.

17. The data read-out system as claimed in claim 9, wherein the switch signal generator comprises:
a first comparator, comparing the performance indicator with an upper performance threshold level, and generating a first comparison result to set a latch circuit when the performance indicator is greater than the upper performance threshold level;
a second comparator, comparing the performance indicator with a lower performance threshold level, and generating a second comparison result to clear the latch circuit when the performance indicator is less than the lower performance threshold level; and
the latch circuit, generating the switch signal with a high level to indicate that the read performance is bad when the latch circuit is set, and generating the switch signal with a low level to indicate that the read performance is good when the latch circuit is cleared.
